(19) United States
(12) Patent Application Publication
(10) Pub. No.: US 2010/0255452 A1
(43) Pub. Date: Oct. 7, 2010

(54) Rehabilitation and training device and methods

(76) Inventors: Kenneth W. Coffey, Tulsa, OK (US); James Phillip Jones, Markham (CA)

Correspondence Address: Jeffrey J. Vaitekunas, 5026 Astronaut Drive, Fairview, PA, 16415, US

(21) Appl. No.: 12/384,555

(22) Filed: Apr. 6, 2009

(51) Int. Cl. G09B 19/00

(52) U.S. Cl. 434/258

(57) ABSTRACT

Training and rehabilitation systems and methods involving providing a training system having buttons arranged within a span of at least 36 inches, each of the buttons associated with a light configured to indicate its button to a user. A light is illuminated, thereby indicating to the user a designated button desired for depressing. The depression of one or more of the buttons by the user is determined. A relationship may be determined between the designated buttons and the depression of the buttons. A training regimen may be based on the determined relationship between the designated buttons and the depression of the buttons. The determined training regimen may be implemented using the training system.

### FIELD OF THE INVENTION

The present invention relates, in general, to rehabilitation and training devices and methods and, more particularly, to physical rehabilitation, perception training, and motor/eye coordination improvement devices and methods.

### BACKGROUND OF THE INVENTION

Enhancing human performance has gained considerable attention in the last 20 years. Athletics has been the most popular sector in our society that has studied and searched for this competitive edge. However, this search is not isolated to the professional level. Today, many parents and coaches at the grass roots level enroll their athletes in a variety of specialized programs in the quest to improve performance in their respective sport. These training programs may range from physical conditioning to sport specific related skills. But, little consideration is ever given to train an athlete's visual system.

The importance of good vision in the participation and enjoyment of sport activities cannot be overemphasized. Vision is not always appreciated by parents, athletes, and coaches because they do not realize that deficiencies in visual skills will decrease optimal athletic performance. However, the fact is, to play any sport well, you have to see well.

Individuals may have a misperception that good eyesight equals good vision. This is not necessarily true. Vision is the process a person has wherein they obtain meaning from what they see. Whatever the sport, participation involves the eyes feeding information of the environment to the brain, which then interprets it. Once this information is processed and a strategy is formulated, the motor system is activated allowing the body to respond appropriately. When the eye messages are inaccurate, incomplete or not at the correct time, performance will suffer greatly. Vision is the critical mechanism controlling an athlete's performance.

Enhancing human performance may be even more critical after an injury or adverse event has occurred. A person may have conditions such as quadriplegia, hemiplegia or amputation or may have visual and/or visuomotor impairment. For this group of people, enhancing their visuomotor skills may lead to recovery or at least an improved quality of life.

For reasons stated above, and for other reasons which will become apparent to those skilled in the art upon reading the present specification, there is a need for systems and methods that provide for rehabilitation and training. There is a particular need for physical rehabilitation, perception training, and motor/eye coordination improvement devices and methods. The present invention fulfills these and other needs, and addresses deficiencies in known systems and techniques.

### SUMMARY OF THE INVENTION

Training and rehabilitation systems and methods involving providing a training system having buttons arranged within a span of at least 36 inches, each of the buttons associated with a light configured to indicate its button to a user. A light is illuminated, thereby indicating to the user a designated button desired for depressing. The depression of one or more of the buttons by the user is sensed. A relationship may be determined between the designated buttons and the sensed depression of the buttons. A training regimen may be based on the determined relationship between the designated buttons and the sensed depression of the buttons. The determined training regimen may be implemented using the training system.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

The novel features of the invention are set forth with particularity in the appended claims. The invention itself, however, both as to organization and methods of operation, together with further objects and advantages thereof, may best be understood by reference to the following description, taken in conjunction with the accompanying drawings in which:

FIG. 1 is a plan view of a visuomotor training system in accordance with embodiments of the present invention;

FIG. 2 is an illustration of approximate relative sizes of a person and a visuomotor training system in accordance with embodiments of the present invention;

FIG. 3 is a side cutaway view of a sensor element of a visuomotor training system in accordance with embodiments of the present invention; and

FIG. 4 is a flow chart of a method of visuomotor training in accordance with embodiments of the present invention.

In the following description of the illustrated embodiments, references are made to the accompanying drawings, which form a part hereof, and in which is shown by way of illustration various embodiments in which the invention may be practiced. It is to be understood that other embodiments may be utilized, and structural and functional changes may be made without departing from the scope of the present invention.

### DETAILED DESCRIPTION OF THE INVENTION

The present invention relates, in general, to rehabilitation and training devices and methods and, more particularly, to physical rehabilitation, perception training, and motor/eye coordination improvement devices and methods that, for example, improve peripheral awareness, concentration, reaction time, visual processing, decision-making under rising levels of stress and speed and span of recognition.

Methods and devices employing physical rehabilitation, perception training, and motor/eye coordination improvement devices and methods in accordance with the present invention may incorporate one or more of the features, structures, methods, or combinations thereof described herein below. For example, physical rehabilitation, perception training, and motor/eye coordination improvement devices and methods may be implemented to include one or more of the features and/or processes described below. It is intended that such a device or method need not include all of the features and functions described herein, but may be implemented to include one or more features and functions that, alone or in combination, provide for unique structures and/or functionality.

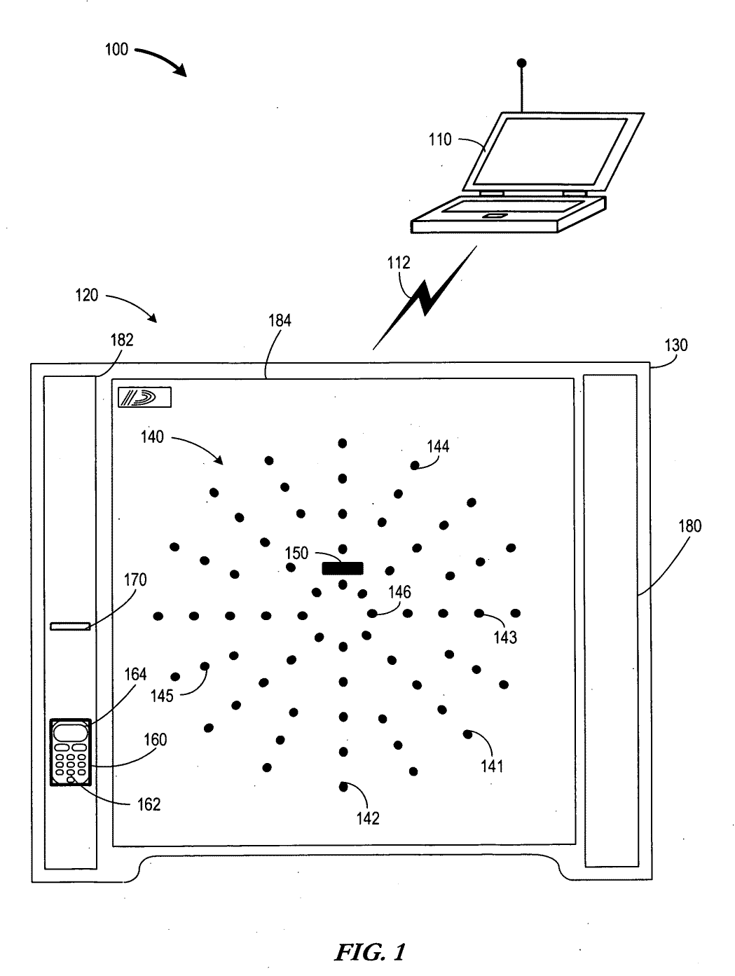

FIG. 1 is a plan view of a visuomotor training system 100 in accordance with embodiments of the present invention. The visuomotor training system 100 is illustrated as a board system 120 having a frame 130, which may optionally be in communications with a controller 110. The frame 130 includes a programming section 182, a training section 184, and an auxiliary section 180. The training section 184 includes an array of light buttons 140 useful for training and rehabilitation purposes in accordance with embodiments of the present invention.

The light buttons 140 include a plurality of individual buttons 141, 142, 143, 144, 145, 146, for example, arranged to provide an effective pattern useful for visuomotor training and rehabilitation. For example, individual button 146 may be part of an inner ring of the light buttons 140, individual buttons 141, 142, and 144 may be part of an outer ring of light buttons 140, and individual buttons 143 and 145 may be part of their respective intermediate rings of light buttons 140. In a particular embodiment, the visuomotor training system 100 is approximately 5 foot by 4 with the training section 184 containing 64 small red square target buttons arranged in five nested rings. The light buttons 140 are illustrated in FIG. 1 as having 5 rings of buttons, each ring having at least eight individual buttons, for example, however other configurations of buttons and other geometric patterns may be utilized in alternate embodiments in accordance with the present invention.

In a particular embodiment, the training section 184 may span about 44 inches and contain 64 target buttons about 0.64 inches in diameter. The buttons may be arranged in five concentric circles having a radius of about 4 inches, 8.5 inches, 13 inches, 17 inches, and 22 inches respectively.

The visuomotor training system 100 may be used to improve the visuomotor skills of a user. For example, an athlete or other professional who relies on visuomotor skills may use the visuomotor training system 100 to provide the same training benefits as persons such as those whose visual and motor function has been compromised by injury or disease. For persons with visual and visuomotor impairment the visuomotor training system 100 may be used to train compensatory search strategies, improve oculomotor skills such as localization, fixation, gaze shift, and tracking, increase peripheral visual awareness, visual attention and anticipation, and improve eye-hand coordination and visuomotor reaction time. For persons with motor impairment the visuomotor training system 100 may be used to increase active upper extremity range of motion and coordination, muscular and physical endurance and improve motor planning. For example, the visuomotor training system 100 may be used to improve function in children or adults with limitations from stroke, head injury, amputation, spinal cord injury and orthopedic injury. The board system 120 may be wall mounted and adjustable to accommodate users of different heights, may be table mounted and configured to accommodate a wheelchair, or may be mounted in other configurations based on the needs of training or rehabilitation.

The programming section 182 may include an I/O area 160 having a display 164 and a keypad 162, for example, that provides for entering data into the visuomotor training system 100 and determining output from the visuomotor training system 100. For example, in a particular embodiment the I/O area 160 may have 37 operating keys, which may control four modes of operation, six light display speeds, three working areas, four quadrants of training section 184, run times of 30, 60 or 240 seconds, and 1 to 7 digits of display with display capabilities of 1 to 0.1 second.

A secondary display 170 may be used, for example, to provide an indication of the state of the visuomotor training system 100. For example, the secondary display 170 may be a solid color indicator having red and green as available outputs. Green may be displayed when the visuomotor training system 100 is running, and red may be displayed when the visuomotor training system 100 needs attention. A trainer may look from time to time as a user is training on the visuomotor training system 100, and if the trainer observes that the secondary display 170 is green, the trainer may allow the training session to continue. If the trainer observes that the secondary display 170 is red, the trainer may intervene in the training of the user.

The training section 184 may include a display 150, such as, for example, a series of 7 segment LED elements, useful for providing feedback to the user during training or for providing auxiliary training modes. The user may be told to focus on the display 150 while performing the training, and the display 150 may indicate progress, time remaining, speed, or other parameter of interest to the user.

In alternate embodiments in accordance with the present invention, alternately or additionally the controller 110 may be used with the visuomotor training system 100. The controller 110 may be used for programming the visuomotor training system 100, for receiving information from the visuomotor training system 100 related to user parameters, for recording user performance, for diagnosing user deficiencies, or for remotely controlling the visuomotor training system 100, for example. The controller 110 may be electrically connected to the board system 120 by a cable such as using Ethernet, or direct wiring, or the controller 110 may be electrically connected to the board system 120 by a wireless link 112 as illustrated in FIG. 1. The wireless link 112 may be, for example, a local area network using a short-range wireless communication interface, such as an interface conforming to a known communications standard, such as Bluetooth or IEEE 802 standards, or other communication method. In further embodiments, the controller 110 may be incorporated into the board system 120, the controller 110 may be linked to two or more board system 120 units concurrently, or other network arrangements.

Embodiments of the visuomotor training system 100, in terms of size, button configuration, and number of program options, enable the visuomotor training system 100 to be used in treatment with a variety of age groups and rehabilitation conditions. The simplicity and straightforwardness of the response required (striking the button, for example) enables persons with limited comprehension to understand the demands of the task. The ability to limit presentation to the inner ring of lights or other areas of interest, coupled with the ability to lower the position of the training section 184 allows it to be used by persons with restricted upper extremity range of motion, wheelchair users, and children. The button may be struck with any part of the hand such as the palm, fingers, or back of the hand. This allows persons with limited prehension due to conditions such as quadriplegia, hemiplegia or amputation to successfully perform their training and/or rehabilitation on the visuomotor training system 100.

In alternate embodiments in accordance with the present invention, the light buttons 140 may be used to program the visuomotor training system 100. A trainer may put the visuomotor training system 100 into a learning mode, and the trainer may select areas of interest to either include, exclude, increase activity, decrease activity, or other desired variation. For example, the light buttons 140 may be used to select quadrants designated as areas of needed improvement, may select span limits, or select other desired inclusion or exclusion parameters.

Presentation of exercise drills as games of skill makes the visuomotor training system 100 exercises fun while challenging users to give their best effort. The ability of the visuomotor training system 100 to select or adapt to different speeds of stimulus presentation from self-pacing modes to automatic presentation modes enables use with persons with varying speeds of information processing. The visuomotor training system 100 in self-pacing modes may be used to facilitate visual scanning and increase visual reaction time in persons who have difficulty executing adequate search patterns due to oculomotor impairment, visual inattention and neglect, and hemianopsia.

Automatic presentation modes and digit flash options may be used to challenge high functioning persons who must demonstrate rapid information processing and mental flexibility in order to resume demanding tasks such as driving, engaging in sports activities and work. Varying the length of the presentation from, for example, 30 seconds to 240 seconds, allows the therapist to prevent fatigue in persons with limited scanning ability and also challenge sustained attention in persons who have difficulty maintaining vigilance. Both self-pacing modes and automatic presentation modes may be used by persons with upper extremity limitations to increase active range of motion and coordination.

In other embodiments, the visuomotor training system 100 may be used to challenge the peripheral visual system. Peripheral visual attention is needed to protect an individual from potential dangers in the environment, and speed in searching the peripheral visual field is critical to safety in environments involving rapid visual changes such as is encountered in driving, for example.

In particular embodiments of visuomotor training system 100, the size of the training section 184 inherently elicits a combination of head turning and eye movement which is the natural scanning strategy initiated when attending to peripheral visual stimuli. In further embodiments, the light buttons may be identical, which eliminates the need for discrete identification and instead elicits the more automatic response of visual localization compatible with the function of peripheral attention. This capacity enables the visuomotor training system 100 to challenge the peripheral attention skills needed for driving, and orientation to and negotiation of the environment at a level few clinical activities can achieve.

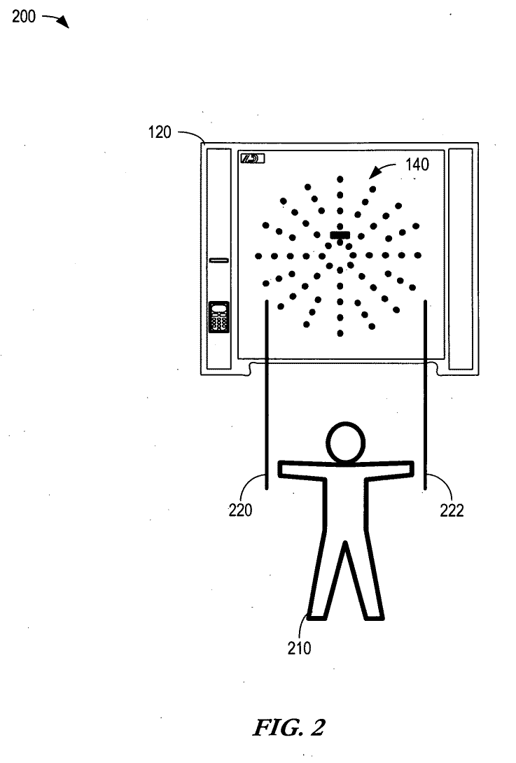

FIG. 2 is an illustration of approximate relative sizes of a person 210 and a visuomotor training system 100 in accordance with embodiments of the present invention. An average adult may have a span of reach from a left limit 220 to a right limit 222. In particular embodiments, the light buttons 140 may be provided in a pattern dimensioned to span the full range from the left limit 220 to the right limit 222. For example, the left limit 220 to the right limit 222 may be a span of about 44 inches or may be within a range of about 36 and about 70 inches.

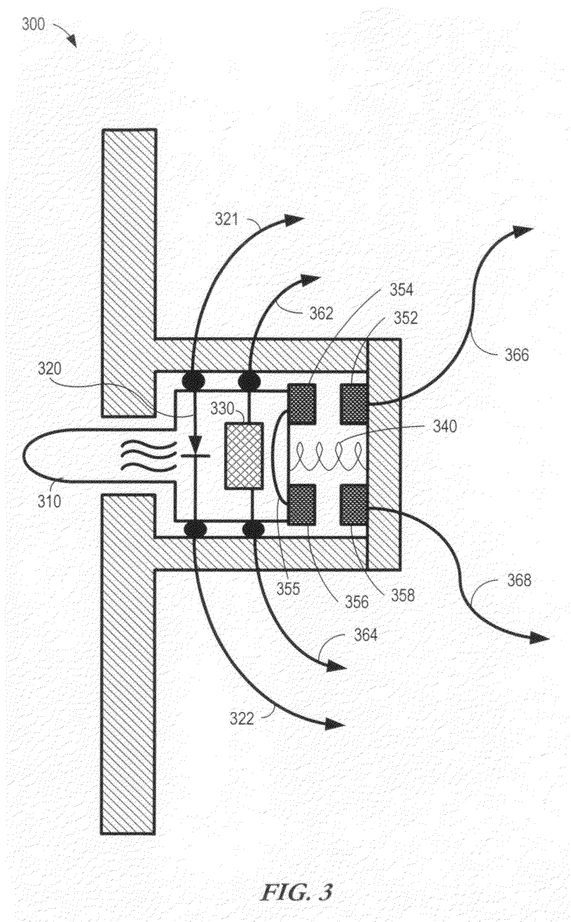

FIG. 3 is a side cutaway view of a button element 300 of the visuomotor training system 100 in accordance with embodiments of the present invention. A button 310 covers a single light bulb 320 which illuminates based on identified parameters or randomly when the training section 184 is in use. The button 310 may have the light bulb 320 incorporated into it, or the light bulb 320 may be positioned behind or adjacent the button 310 so that the light bulb 320 is observable when the button 310 is in its extended position. For example, the light bulb 320 may be an LED. The light bulb 320 is illustrated with a positive lead 321 and a negative lead 322 that provide signal and ground potentials for the light bulb 320.

In particular embodiments, the button element 300 includes a sensor 330 configured to sense the intensity with which the button 310 is struck by the user. The sensor 330 may be incorporated into the button 310 as illustrated, or may be placed near to the button 310.such that the sensor 330 can discriminate the intensity with which the button element 300 is struck. For example, the sensor 330 may be a strain gage connected by leads 362, 364 to a bridge circuit configured to sense the strain in the button 310, which corresponds to the hit intensity. In an alternate sensing arrangement, the sensor 330 may be a PVDF polymer with piezoelectric properties and the leads 362, 364 may be connected to a charge measuring circuit or a voltage measuring circuit configured to sense the intensity with which the button element 300 is struck. Other sensor arrangements may be utilized without departing from the scope of the present invention.

Sensing the intensity of button strike may be used to determine weak areas of the user, or to determine speed of strike, or other useful parameters. For example, if a user is striking hard enough to cause concern or damage, the visuomotor training system 110 may alert a trainer or stop the training session to protect the user or the visuomotor training system 110 itself. Sensing a change in strike intensity over time may be used as an indication of fatigue, and fatigue may be used as a parameter for training or rehabilitation training or measurement.

A spring 340 may be used to return the button 310 to an extended position after the button 310 is hit or depressed by the user. Electrodes 352, 354, 366, 368 may be used to detect when the button 310 is hit or depressed. For example, leads 366, 368 may connect the button element 300 to control circuitry that senses a switch closure when the button 310 is depressed. In this particular arrangement, depressing button 310 places electrode 352 in contact with electrode 354, and electrode 356 in contact with electrode 358. Electrode 354 is illustrated in FIG. 3 to be electrically connected to electrode 354 by a wire 355 in the button 310. Depressing the button 310 then completes a switch closing between the leads 366, 368, which may be de-bounced, latched, or otherwise filtered as desired by sensing circuitry. Although a switch system is illustrated for purposes of clarity, other sensing arrangements may be used that incorporate capacitive sensing, magnetic sensing, or other sensing methodologies. For example, using a capacitive sensing arrangement, both sensing the depression of the button 310 and sensing the intensity with which the button element 300 is struck may be accomplished by the same sensor.

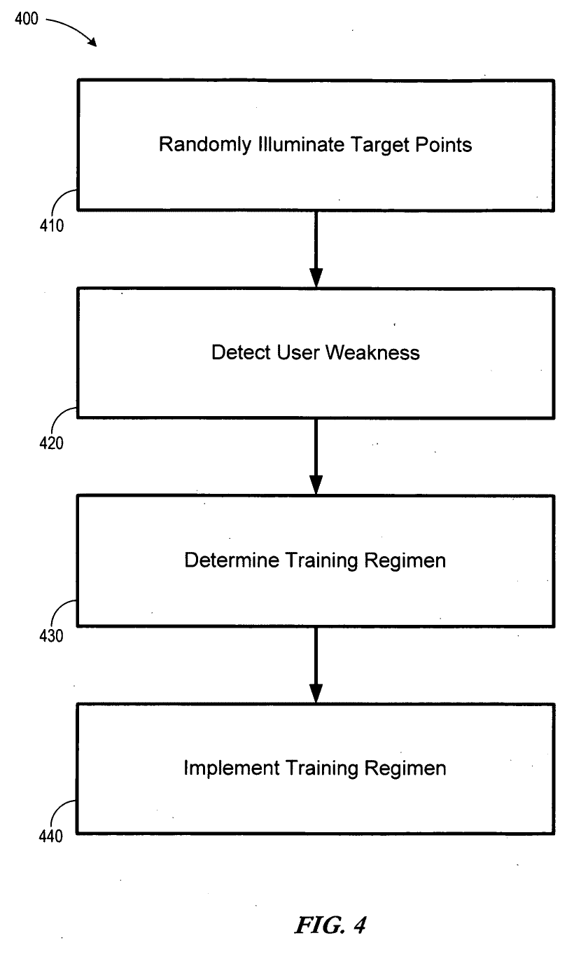

FIG. 4 is a flow chart of a method 400 of visuomotor training in accordance with embodiments of the present invention. A variety of training and testing tasks may be generated using either self paced or apparatus paced modes. In a particular self paced training mode, (herein identified as mode A for convenience) a target button illuminates in a random location on the training section 184. The user must locate the light and strike its associated button with the hand as quickly as possible. When struck, the visuomotor training system 100 beeps and extinguishes the light and another target light appears in a random location on the training section 184. The user proceeds to strike the target light buttons 140 for the duration of the exercise. The numbers of light “hits” are recorded and displayed at the end of the run. In a particular apparatus paced mode (herein identified as mode B for convenience), the light is illuminated for a preselected period of time of 5, 3, 2, 1 or 0.75 seconds, for example. The user must strike the target within the preselected time to score a “hit”. Apparatus paced exercises may be more challenging than self-paced exercises.

In particular embodiments, different options may be selected to accompany one or both of user paced or apparatus paced modes depending on the needs of the user and/or desired therapy. Exercises may be preselected to run 30, 60, or 240 seconds, for example. Longer durations are useful for working on maintaining sustained attention; shorter durations for exercises requiring high intensity performance. The board system 120 may be programmed so that light buttons 140 appear only or preferentially within one or more quadrants to challenge the user who may have difficulty scanning or reaching in a certain direction or to eliminate areas unreachable by certain users. The training surface may also be adjusted between use of the full training section 184 (light buttons 140 in all five rings illuminate) the middle training section 184 (the inner 4 rings of the training section 184 illuminate), or the inner training section 184 (the central three rings illuminate), for example. The middle and inner training section 184 surfaces may be more suitable for children or adults with limited active range of motion or strength.

In another embodiment, herein referred to as a flash mode option, the LED display 150 in the center of the training section 184 may be programmed to display from one to seven digits periodically during the exercise run. The user must call out the numbers while striking the target buttons, a task which requires the ability to monitor and shift attention smoothly between the central and peripheral visual field. This program option significantly increases the cognitive demands on the user. Other instructional variations may be used to increase the cognitive requirements of the training tasks. For example, the user may be asked to multiply or add the digits in the LED display while striking one or more of the light buttons 140 on the training section 184. Or, on B mode, the user may be required to refrain from hitting one or more of light buttons 140 when they appear in certain areas of the training section 184 or to strike light buttons 140 with a certain hand only.

On completion of an exercise run, the visuomotor training system 100 may print outs an analysis of the user's performance, which may include, for example, a comparison of reaction time and accuracy in the four quadrants of training section 184. This provides the clinician with objective data on the user's strengths and weaknesses in performance and assists in evaluation, treatment planning and documentation.”

In other embodiments of methods in accordance with the present invention, the visuomotor training system 100 may be used for training. One of the most important skills in the field of tactical and counter-terrorism training is the ability to dynamically read and react to a variety of situations while under extreme levels of stress.

In a further embodiment of methods in accordance with the present invention, the user may perform a “run” for a specific period of time, for example 30 or 60 seconds. The user's performance may then be analyzed by the system to find a low performing area such as, for example, a single quadrant. The next run can then be weighted to have the weak quadrant display more often thus training the user's weaker areas of performance. The weighting may be performed by having the system generate random numbers associated with the buttons, and then apply a greater frequency to the weighted quadrant by discounting a percentage of the buttons outside the weak quadrant by some multiple. The weighting multiple may also be chosen and be entered into the system program in other methodologies.

The visuomotor training system 100 may be used to operate a program that is aimed at first evaluating and then improving those dynamic skills which will have a direct effect or impact on job performance. First, current levels and development potential for selection purposes are assessed, such as by randomly illuminating target points 410, and sensing responses from the user such as response timing, error rates, miss rates, missed areas, local timing differences, or other sensed responses. Predictions are made as to how well an individual will perform a given task; how they are most likely to react in a given situation; an analysis of the effects of stress on their performance levels, or other prediction. For example, detecting user weakness 420 may be accomplished using the sensed responses from randomly illuminating target points 410. Those weaknesses are then used as a base to determine training regimen 430 designed to improve skills and performance. The training program is then implemented 440 to correct of improve the users identified weaknesses.

The user may be trained to absorb maximum amounts of information at a glance, and process that information rapidly and orderly, so that the decision, and consequently the response is correct, instantaneous and effective. Training improves the ability to concentrate on a central target, and at the same time maintain an acute awareness of peripheral action, so as to react instantly to a threat that is initiated away from a central field of view.

It is understood that the components and functionality depicted in the figures and described herein may be implemented in hardware, software, or a combination of hardware and software. It is further understood that the components and functionality depicted as separate or discrete blocks/elements in the figures may be implemented in combination with other components and functionality, and that the depiction of such components and functionality in individual or integral form is for purposes of clarity of explanation, and not of limitation.

Illustrations of method steps, such as, for example, the steps illustrated in FIG. 4 show steps sequentially and in a particular order. There is no need to perform the steps in the order illustrated. Deviating from the illustrated order for some or all of the steps is contemplated by the inventor, and does not depart from the scope of the present invention.

Each feature disclosed in this specification (including any accompanying claims, abstract, and drawings), may be replaced by alternative features having the same, equivalent or similar purpose, unless expressly stated otherwise. Thus, unless expressly stated otherwise, each feature disclosed is one example only of a generic series of equivalent or similar features.

While preferred embodiments of the present invention have been shown and described herein, it will be obvious to those skilled in the art that such embodiments are provided by way of example only. Numerous variations, changes, and substitutions will be apparent to those skilled in the art without departing from the invention. Accordingly, it is intended that the invention be limited only by the scope of the appended claims.

What is claimed is:

1. A training method comprising:
providing a training system having a plurality of buttons arranged within a training section of the training system, the training section having a span of at least 36 inches, each of the plurality of buttons electrically connected to a controller configured to determine a state of the plurality of buttons, each of the plurality of buttons associated with a light configured to indicate a particular button within the plurality of buttons;
illuminating a light, thereby indicating to a user a designated button of the plurality of buttons that is designated for depressing;
sensing the depression of one or more of the plurality of buttons;
determining a relationship between the designated button and the sensed depression of the one or more of the plurality of buttons using the controller;
determining a training regimen based on the determined relationship between the designated button and the sensed depression of the one or more of the plurality of buttons; and
implementing the determined training regimen using the training system.

2. The method of claim 1, further comprising using one or more of the plurality of buttons to indicate an area of interest of the training section, the area of interest designating to the controller a particular training regimen.

3. The method of claim 3, wherein the particular training regimen excludes the indicated area of interest from the determined training regimen.

4. The method of claim 3, wherein the particular training regimen increases the occurrence of lighting a particular light in the area of interest during the determined training regimen.

5. The method of claim 1, wherein one or more of the plurality of buttons comprises a sensor configured to sense the intensity of the depression of the one or more of the plurality of buttons, the method comprising sensing the intensity of the depression of the one or more of the plurality of buttons, and using the sensed intensity to alter the determined training regimen.

6. The method of claim 5, wherein altering the determined training regimen comprises stopping the determined training regimen.

7. The method of claim 5, wherein altering the determined training regimen comprises altering a rate of illumination of lights during the determined training regimen.

8. A training system, comprising:
a plurality of buttons arranged within a training section of the training system, the training section having a span of at least 36 inches, each of the plurality of buttons electrically connected to a controller configured to determine a state of the plurality of buttons, each of the plurality of buttons associated with a light configured to indicate a particular button within the plurality of buttons; and
a plurality of sensors, each of the plurality of sensors associated with a portion of the training section, each of the plurality of sensors electrically connected to sensing circuitry configured to provide a signal to the controller, the signal indicative of the intensity with which one or more buttons within the portion of the training section are depressed.

9. The system of claim 8, further comprising:
a processor coupled to the controller, the processor configured to determine a relationship between a designated button and a sensed depression of the designated button, the processor using the determined relationship to define an order of subsequent button designations.

10. The system of claim 9, wherein the processor is configured to use the determined relationship to define both the order and timing of subsequent button designations.

11. The system of claim 9, wherein the processor is configured to use the signal indicative of the intensity to determine a weakness area.

12. The system of claim 11, wherein the training section is divided into a plurality of regions, and wherein the processor is configured to use the determined weakness area to preferentially indicate the buttons within one of the plurality of regions during a training session.

13. A training system, comprising:
a training system having a plurality of buttons arranged within a training section of the training system, the training section having a span of at least 36 inches, each of the plurality of buttons electrically connected to a controller configured to determine a state of the plurality of buttons, each of the plurality of buttons associated with a light configured to indicate a particular button within the plurality of buttons;
means for illuminating a light, thereby indicating to a user a designated button of the plurality of buttons that is designated for depressing;
means for sensing the depression of one or more of the plurality of buttons;
means for determining a relationship between the designated button and the sensed depression of the one or more of the plurality of buttons using the controller;
means for determining a training regimen based on the determined relationship between the designated button and the sensed depression of the one or more of the plurality of buttons; and
means for implementing the determined training regimen using the training system.

14. The system of claim 13, further comprising:
means for indicating an area of interest of the training section, the area of interest designating to the controller a particular training regimen.

15. The system of claim 14, wherein the particular training regimen excludes the indicated area of interest from the particular training regimen.

16. The system of claim 14, wherein the particular training regimen increases the occurrence of lighting a particular light in the area of interest during the particular training regimen.

17. The system of claim 13, further comprising:
means for sensing the intensity of the depression of the one or more of the plurality of buttons.

18. The system of claim 13, further comprising:
means for altering a rate of illumination of lights during the particular training regimen.
